(19) United States
(12) Patent Application Publication
(10) Pub. No.: US 2021/0252959 A1
(43) Pub. Date: Aug. 19, 2021

(54) ELECTRIC SOLID AXLE

(71) Applicant: Schaeffler Technologies AG & Co. KG, Herzogenaurach (DE)

(72) Inventors: Matthew Payne, Glenmont, OH (US); Ayyalraju Satyaseelan, Wooster, OH (US)

(73) Assignee: Schaeffler Technologies AG & Co. KG, Herzogenaurach (DE)

(21) Appl. No.: 17/172,242

(22) Filed: Feb. 10, 2021

Related U.S. Application Data
(60) Provisional application No. 62/977,522, filed on Feb. 17, 2020.

(51) Int. Cl. B60K 1/00; F16H 48/08

(52) U.S. Cl. CPC B60K 1/00; B60K 2001/001; F16H 48/08

(57) ABSTRACT

A solid electric axle is suitable for use on a heavy duty work vehicle. One or two motors are concentric with the half-shafts. The main housing includes a center support and two other pieces which are bolted to the center support. A linear actuator is used to lock the differential and also to select a neutral mode in which the rotors of the motors can be stationary while the vehicle moves.

### CROSS-REFERENCE TO RELATED APPLICATIONS

This application claims priority to U.S. Provisional Application 62/977,522 filed Feb. 17, 2020, the entire disclosure of which is incorporated by reference herein.

### TECHNICAL FIELD

The disclosure pertains to an electric solid axle. More particularly, the disclosure pertains to an electric solid axle having neutral and locked operating modes.

### BACKGROUND

To improve ride-quality, many vehicles utilize a suspension system in which the wheels are linked to the primary vehicle mass via springs and shock absorbers. Thus, as the wheels closely follow the terrain, the vertical position of the majority of the vehicle and the occupants varies only slightly. The passengers and cargo are thereby isolated to a substantial extent from bumps, holes, etc.

Passenger vehicles and trucks are typically propelled by torque applied to a set of wheels, called the driven wheels. Typically, the driven wheels include at least one wheel on the left side of the vehicle and at least one wheel on the right side of the vehicle. Commonly, a single source of power, such as an internal combustion engine, drives wheels on opposite sides of the vehicle via a differential. The differential divides torque approximately equally between the two wheels while permitting the wheels to rotate at slightly different speeds such as when the vehicle turns a corner.

Broadly speaking, two types of arrangements are utilized: solid axle arrangements and independent suspension arrangements. In a solid axle arrangement, the differential is supported in a fixed position relative to the wheels. If the power source is fixed relative to primary vehicle structure, as is common, then the connection between the power source and the differential (typically a drive shaft) is engineered to accommodate relative movement. With an independent suspension arrangement, on the other hand, the differential is rigidly fixed to primary vehicle structure. The connection between the differential and the left and right wheels (called half-shafts) is engineered to accommodate relative movement.

Some vehicles utilize one or more electric traction motors to supplement or to replace the internal combustion engine as the power source. Conventionally, the electric traction motors are fixed to primary structure and connected to the differential in the same fashion as internal combustion engine powertrains.

### SUMMARY

A solid axle includes a main housing, two wheel hubs, two hollow axle tubes, two concentric half-shafts, and an electric drive unit. The two hollow axle tubes rigidly connect the wheel hubs to the main housing. The two concentric half-shafts each extend through one of the axle tubes. Each half-shaft is supported for rotation about a common central axis. The electric drive unit has at least one electric motor with at least one rotor supported within the main housing for rotation about the common central axis. The electric drive unit is configured to supply torque to each of the half-shafts from the at least one electric motor. The electric drive unit may include differential gearing and speed reduction gearing. The differential gearing may be configured to divide torque applied to a differential input member between the two half-shafts while permitting the two half-shafts to rotate at speeds that differ from one another. The speed reduction gearing may be configured to transmit power from the at least one rotor to the differential input member such that the differential input member rotates slower than the rotor. The speed reduction gearing may have a neutral state in which the differential input member is free to rotate while the rotor is stationary. The differential gearing may have a locked state in which the two half-shafts are constrained to rotate at the same speed and all of the power generated by the motor may is transferred to one of the half-shafts. A linear actuator may be configured such that: in a first extreme position, the differential gearing is in an unlocked state and the speed reduction gearing is in the neutral state, in an intermediate position, the differential gearing is in the unlocked state and the speed reduction gearing is in an engaged state, and in a second extreme position, the differential gearing in the locked state and the speed reduction gearing is in the engaged state. Alternatively, the solid axle may include two electric motors and two sets of speed reduction gearing. Each set of speed reduction gearing may be configured to transmit power from a rotor of a respective one of the two electric motors to a respective one of the two half-shafts such that the respective half-shaft rotates slower than the rotor. A locking mechanism may be configured to selectively constrain the two half-shafts to rotate at the same speed.

A solid axle includes a main housing, two wheel hubs, two hollow axle tubes, and electric drive unit, speed reduction gearing, and differential gearing. The two hollow axle tubes rigidly connect the wheel hubs to the main housing. The two concentric half-shafts each extending through a respective axle tube. Each half-shaft is supported for rotation about a common central axis. The electric drive unit has an electric motor with a rotor supported within the main housing for rotation about the common central axis. The speed reduction gearing is configured to transmit power from the rotor to a differential input member such that the differential input member rotates slower than the rotor. The differential gearing is configured to divide torque applied to the differential input member between the two half-shafts while permitting the two half-shafts to rotate at speeds that differ from one another. The speed reduction gearing may have a neutral state in which the differential input member is free to rotate while the rotor is stationary. The differential gearing may have a locked state in which the two half-shafts are constrained to rotate at a same speed and all of the power generated by the motor may is transferred to one of the half-shafts. A linear actuator may be configured such that: in a first extreme position, the differential gearing is in an unlocked state and the speed reduction gearing is in the neutral state, in an intermediate position, the differential gearing is in the unlocked state and the speed reduction gearing is in an engaged state, and in a second extreme position, the differential gearing is in the locked state and the speed reduction gearing in the engaged state. The main housing may include a center support, a motor housing, and a gearbox housing. The motor housing may be bolted to the center support and may encase the electric motor. The gearbox housing may be bolted to the center support and may encasing the speed reduction gearing and the differential gearing. The speed reduction gearing may include first and second planetary gear sets. The first planetary gear set may have a first sun gear fixedly coupled to the rotor, a first ring gear, a first carrier supported for rotation about the common central axis, and a first set of planet gears, each supported for rotation with respect to the first carrier and meshing with the first sun gear and the first ring gear. The second planetary gear set may have a second sun gear fixedly coupled to the first carrier, a second ring gear, a second carrier supported for rotation about the common central axis, and a second set of planet gears, each supported for rotation with respect to the second carrier and meshing with the second sun gear and the second ring gear. One of the first ring gear and the second ring gear may be fixedly coupled to the main housing while the other is selectively coupled to the main housing. A linear actuator may be configured such that: in a first position, the other ring gear is disconnected from the housing; and in a second position, the other ring gear is connected to the housing. In a third position, the linear actuator may lock the differential gearing such that the two half-shafts are constrained to rotate as a unit.

### BRIEF DESCRIPTION OF THE DRAWINGS

FIG. 1 is a schematic cross section of an electric solid axle.

FIG. 2 is a cross sectional view of a first embodiment of an electric drive unit for the electric solid axle of FIG. 1.

FIG. 3 is a detail view of the cross section of FIG. 2.

FIG. 4 is a cross sectional view of a second embodiment of an electric drive unit for the electric solid axle of FIG. 1.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

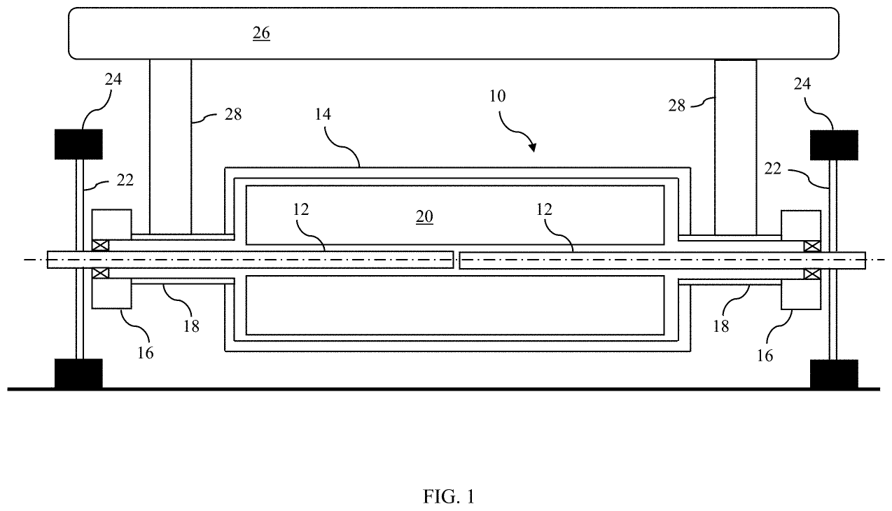

FIG. 1 schematically illustrates an electric solid axle arrangement, as viewed horizontally from behind a vehicle. The electric solid axle 10 includes two concentric half-shafts 12, a main housing 14, two wheel hubs 16, two axle tubes 18 rigidly connecting the wheel hubs to the main housing, and an electric drive unit 20. The electric drive unit 20 is supported within the main housing 14 and supplies torque to each of the half-shafts 12. The electric drive unit 20 includes at least one traction motor and may also include speed reduction gearing, differential gearing, and a locking mechanism as described below. Each half-shaft 12 drives a wheel 22 with a tire 24. For non-steerable wheels (typically rear), the wheels are rigidly fixed to the half-shafts. For steerable wheels (typically front), the wheels are connected by a mechanism that permits transfer of torque while allowing the wheel axis to pivot relative to the axle axis. The electric solid axle 10 is attached to vehicle structure 26 by suspension 28. The suspension typically includes springs and shock absorbers located near each wheel.

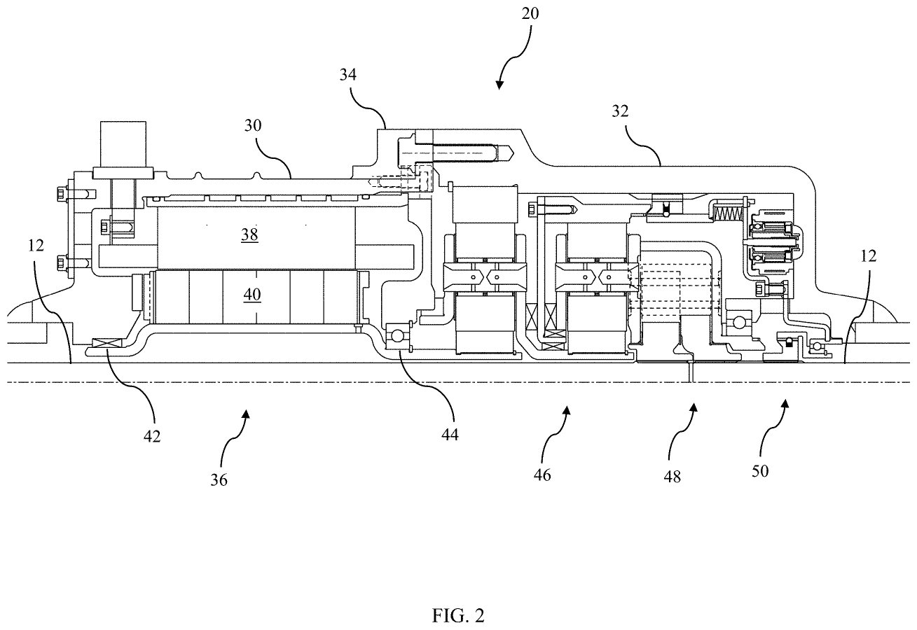

FIG. 2 illustrates a first embodiment of the electric drive unit 20. Main housing 14 includes three separate pieces, motor housing 30, gearbox housing 32, and center support 34. After installation of internal components, motor housing 30 and gearbox housing 32 are each bolted to center support 34 to form a rigid housing structure. Traction motor 36 includes a stator 38 fixed to motor housing 30 and a rotor 40. One end of rotor 40 is supported with respect to motor housing 30 by bearing 42. The other end of rotor 40 is supported with respect to center support 34 by bearing 44. Speed reduction gearing 46, differential gearing 48, and actuator 50 are housed on the opposite side of center support 34 from the traction motor.

Speed reduction gearing 46 and differential gearing 48 both utilize planetary gear sets. A planetary gear set includes a carrier and at least one set of planet gears that are supported for rotation with respect to the carrier. The planet gears rotate about axes that are offset from a central axis of the carrier. If the carrier rotates, the planet gear axes rotate with it. An external tooth gear that is located radially inside the planets and meshes with each of the planet gears of at least one of the sets of planet gears is called a sun gear. An internal tooth gear that is located radially outside the planets and meshes with each of the planet gears of at least one of the sets of planet gears is called a ring gear. A planetary gear set has two degrees of freedom with respect to element speeds. In other words, once the rotational speeds two components are specified, the rotational speeds of the remaining components are determined.

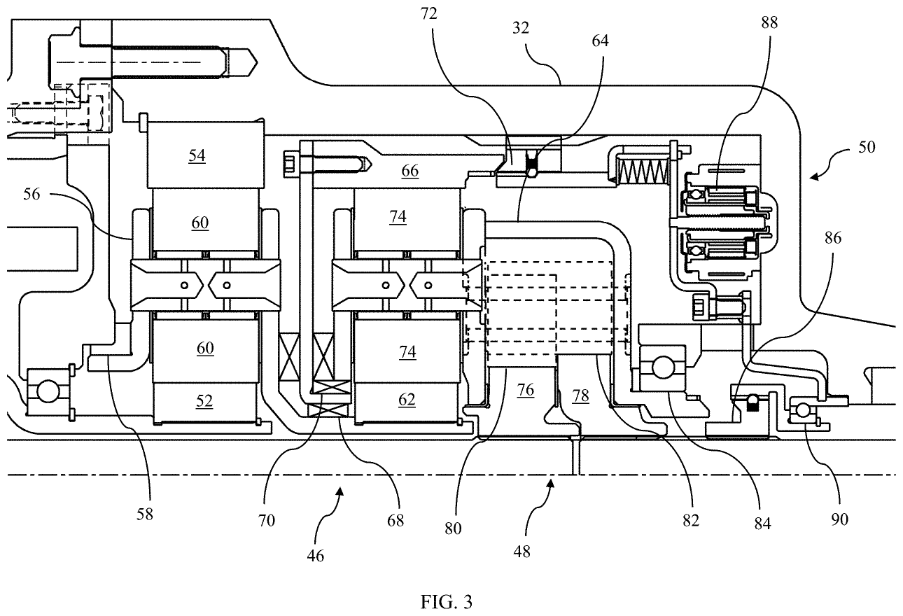

FIG. 3 shows the speed reduction gearing 46, differential gearing 48, and actuator 50 in more detail. The speed reduction gearing 46 includes two simple planetary gear sets. Sun gear 52 is splined to the rotor 40. Ring gear 54 is fixed to gearbox housing 32. Carrier 56 is supported relative to center support 34 by bushing 58. Planet gears 60 rotate with respect to carrier 56 and mesh with sun gear 52 and ring gear 54. Sun gear 62 is splined to carrier 56. Carrier 64 and ring gear 66 are supported with respect by carrier 56 via bearings 68 and 70. Ring gear 66 is selectively held against rotation by synchronizer 72 which, when engaged, connects it to gearbox housing 32. Planet gears 74 rotate with respect to carrier 64 and mesh with sun gear 62 and ring gear 66. Carrier 64 is the output of speed reduction gearing 46 and the input to differential gearing 48. When synchronizer 72 is engaged, the speed of carrier 64 is equal to the speed of rotor 40 multiplied by [(N₅₄+N₅₂)(N₆₆+N₆₂)/(N₅₂*N₆₂)] where N₅₂, N₅₄, N₆₂, and N₆₆ represent the number of gear teeth of the respective gear.

Differential gearing 48 includes carrier 64, sun gear 76, sun gear 78, planet gears 80, and planet gears 82. Planet gear 80 and 82 each rotate with respect to carrier 64. Each planet gear 80 meshes with sun gear 76 and with one of the planet gears 82. Similarly, each planet gear 82 meshes with sun gear 78 and with one of the planet gears 80. Sun gear 76 is splined to one of the half-shafts. Sun gear 78 is splined to the other half-shaft. In normal operation, differential gearing 48 divides the torque from the speed reduction gearing 46 between the two half-shafts. The average of the two half-shaft speeds is constrained to be equal to the speed of carrier 64, but one may rotate faster than carrier 64 while the other rotates slower than carrier 64. If either wheel loses traction in this operating mode, the system is no longer able to effectively deliver torque to the other wheel. One end of carrier 64 is supported by bearing 84. Synchronizer 86 selectively couples sun gear 78 to carrier 64. When synchronizer 86 is engaged, the differential gearing 48 operates in a locked differential mode. The speeds of both half-shafts are constrained to be equal to the speed of carrier 64, and therefore equal to each other. If one wheel loses traction in this mode, torque may still be delivered to the other wheel.

Actuator 50 is used to select a desired operating mode. Linear actuator 88 moves a linkage left or right based on an electrical signal from a controller. At one extreme position, neither synchronizer 72 nor synchronizer 86 are engaged. In this state, differential gearing 48 is open (permits speed differences) and speed reduction gearing 46 is in neutral. In other words, the speed of rotor 40 is not linked to the speed of carrier 64 and no torque is transferred between the motor and the wheels. This state is desirable if the vehicle is being propelled by a different power source. The wheels can turn without the motor rotating, so parasitic losses associated with motor rotation are avoided. As the linkage moves leftward, synchronizer 72 connects ring gear 66 to the housing, establishing the power flow path through the speed reduction gearing. In this intermediate position, synchronizer 86 remains disengaged, so the differential gearing remains in open condition. Further leftward movement of the linkage engages synchronizer 86, placing the differential gearing in the locked condition. Note that the linkage is connected to synchronizer 86 by a bearing 90 such that the synchronizer can rotate with the half-shaft while the linkage does not rotate.

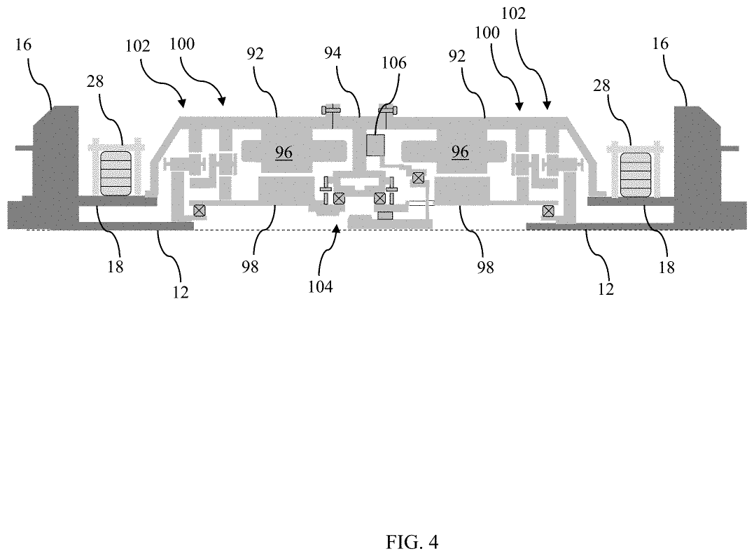

FIG. 4 illustrates a second embodiment. In this embodiment, main housing 14 includes three pieces, two side housings 92 and a center support 94, which are rigidly bolted together. The electric drive unit 20 includes two motors, each with a stator 96 fixed to one of the side housings, and a rotor 98 supported by the center support and one of the side housings. Each rotor is drivably connected to one of the half-shafts via speed reduction gearing including two planetary gear sets 100 and 102. The specific connections among these gear sets is analogous to those of the first embodiment. Although no disconnect is illustrated, one could be added in a similar fashion to the first embodiment if desired. In this second embodiment, no differential gearing is required because, in a normal mode, the two half-shafts are driven independently. Even in this normal mode, loss of traction at one wheel does not interfere with transmission of power to the other wheel. However, engagement of optional coupler 104 places the axle in a locked mode of operation in which the speeds of the two half-shafts are equal. The coupler is engaged using linear actuator 106. In locked mode, torque from both motors may be routed to one of the wheels when the other wheel loses traction.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. A solid axle comprising:
a main housing;
two wheel hubs;
two hollow axle tubes rigidly connecting the wheel hubs to the main housing;
two concentric half-shafts each extending through one of the axle tubes, each half-shaft supported for rotation about a common central axis; and
an electric drive unit having at least one electric motor having at least one rotor supported within the main housing for rotation about the common central axis, the electric drive unit configured to supply torque to each of the half-shafts from the at least one electric motor.

2. The solid axle of claim 1 wherein the electric drive unit further comprises:
differential gearing configured to divide torque applied to a differential input member between the two half-shafts while permitting the two half-shafts to rotate at speeds that differ from one another; and
speed reduction gearing configured to transmit power from the at least one rotor to the differential input member such that the differential input member rotates slower than the rotor.

3. The solid axle of claim 2 wherein the speed reduction gearing has a neutral state in which the differential input member is free to rotate while the rotor is stationary.

4. The solid axle of claim 2 wherein the differential gearing has a locked state in which the two half-shafts are constrained to rotate at the same speed and all of the power generated by the motor may be transferred to one of the half-shafts.

5. The solid axle of claim 1 wherein the electric drive unit further comprises:
differential gearing configured to divide torque applied to a differential input member between the two half-shafts while permitting the two half-shafts to rotate at speeds that differ from one another wherein the differential gearing has a locked state in which the two half-shafts are constrained to rotate at the same speed and all of the power generated by the motor may be transferred to one of the half-shafts;
speed reduction gearing configured to transmit power from the at least one rotor to the differential input member such that the differential input member rotates slower than the rotor wherein the speed reduction gearing has a neutral state in which the differential input member is free to rotate while the rotor is stationary; and
a linear actuator, the linear actuator configured to:
in a first extreme position, put the differential gearing in an unlocked state and put the speed reduction gearing in the neutral state,
in an intermediate position, put the differential gearing in the unlocked state and put the speed reduction gearing in an engaged state, and.
in a second extreme position, put the differential gearing in the locked state and put the speed reduction gearing in the engaged state.

6. The solid axle of claim 1 wherein:
the at least one electric motor comprises two electric motors; and
the electric drive unit further comprises two sets of speed reduction gearing each configured to transmit power from a rotor of a respective one of the two electric motors to a respective one of the two half-shafts such that the respective half-shaft rotates slower than the rotor.

7. The solid axle of claim 6 wherein the electric drive unit further comprises a locking mechanism configured to selectively constrain the two half-shafts to rotate at the same speed.

8. A solid axle comprising:
a main housing;
two wheel hubs;
two hollow axle tubes rigidly connecting the wheel hubs to the main housing;
two concentric half-shafts each extending through one of the axle tubes, each half-shaft supported for rotation about a common central axis;
an electric drive unit having an electric motor with a rotor supported within the main housing for rotation about the common central axis;
speed reduction gearing configured to transmit power from the rotor to a differential input member such that the differential input member rotates slower than the rotor; and
differential gearing configured to divide torque applied to the differential input member between the two half-shafts while permitting the two half-shafts to rotate at speeds that differ from one another.

9. The solid axle of claim 8 wherein the speed reduction gearing has a neutral state in which the differential input member is free to rotate while the rotor is stationary.

10. The solid axle of claim 9 wherein the differential gearing has a locked state in which the two half-shafts are constrained to rotate at a same speed and all of the power generated by the motor may be transferred to one of the half-shafts.

11. The solid axle of claim 10 wherein the electric drive unit further comprises a linear actuator configured to:
in a first extreme position, put the differential gearing in an unlocked state and put the speed reduction gearing in the neutral state,
in an intermediate position, put the differential gearing in the unlocked state and put the speed reduction gearing in an engaged state, and
in a second extreme position, put the differential gearing in the locked state and put the speed reduction gearing in the engaged state.

12. The solid axle of claim 8 wherein the main housing comprises:
a center support;
a motor housing bolted to the center support and encasing the electric motor; and
a gearbox housing bolted to the center support and encasing the speed reduction gearing and the differential gearing.

13. The solid axle of claim 12 wherein the speed reduction gearing comprises:
a first planetary gear set having a first sun gear fixedly coupled to the rotor, a first ring gear, a first carrier supported for rotation about the common central axis, and a first set of planet gears, each supported for rotation with respect to the first carrier and meshing with the first sun gear and the first ring gear; and
a second planetary gear set having a second sun gear fixedly coupled to the first carrier, a second ring gear, a second carrier supported for rotation about the common central axis, and a second set of planet gears, each supported for rotation with respect to the second carrier and meshing with the second sun gear and the second ring gear.

14. The solid axle of claim 13 wherein:
one of the first ring gear and the second ring gear is fixedly coupled to the main housing; and
another of the first ring gear and the second ring gear is selectively coupled to the main housing.

15. The solid axle of claim 14 further comprising a linear actuator configured to:
in a first position, disconnect the another ring gear from the housing; and
in a second position, connect the another ring gear to the housing.

16. The solid axle of claim 15 wherein the linear actuator is further configured to:
in a third position, lock the differential gearing such that the two half-shafts are constrained to rotate as a unit.
